(19) United States
(12) Patent Application Publication
(10) Pub. No.: US 2013/0337436 A1
(43) Pub. Date: Dec. 19, 2013

(54) SUBSTRATE COATED WITH NANOPARTICLES, AND USE THEREOF FOR THE DETECTION OF ISOLATED MOLECULES

(71) Applicants: Timothee Toury, Prugny (FR); Marc Lamy De La Chapelle, Fontenay Sous Bois (FR); Hong Shen, Troyes Cedex (FR)

(72) Inventors: Timothee Toury, Prugny (FR); Marc Lamy De La Chapelle, Fontenay Sous Bois (FR); Hong Shen, Troyes Cedex (FR)

(73) Assignee: UNIVERSITE DE TECHNOLOGIE DE TROYES, Troyes (FR)

(21) Appl. No.: 13/821,599

(22) PCT Filed: Sep. 7, 2011
(86) PCT No.: PCT/FR2011/052042

§ 371 Date: Sep. 5, 2013

(30) Foreign Application Priority Data
Sep. 8, 2010 (FR) 10 57129

(51) Int. Cl. G01N 21/65

(52) U.S. Cl. CPC G01N 21/658; Y10S 977/773; Y10S 977/92; B82Y 15/00
USPC 435/5; 435/288.7; 435/7.32; 436/501; 422/82.05; 977/773; 977/920

(57) ABSTRACT

The present disclosure relates to a substrate having a surface comprising nanoparticles or groups of nanoparticles which the linear optical response does not depend on the polarisation of the incident field of a Gaussian beam having an axis of propagation that is directed perpendicularly to the surface of the substrate. The shape or arrangement of the groups of nanoparticles has a Cn-type axis of symmetry perpendicular to the surface, where n is a number equal to three or greater than four, and the shape of the nanoparticles has a Cn-type axis of symmetry perpendicular to the surface, where n is a number no less than three, to allow strong enhancement of the beam close to the surface. The disclosure relates to use of substrates for detection and/or measurement of chemical, biochemical or biological molecules, wherein the molecules can be present in trace amounts in a liquid or other medium.

### FIELD OF THE INVENTION

The invention relates to the field of substrates or other media wherein one surface has nanoparticles particularly having a specific shape and function, and the uses arising therefrom.

In particular, the invention relates to the field of detecting and/or measuring molecules in trace amounts, in liquid or non-liquid media. More specifically for detecting small quantities of molecules for which the optical response is to be enhanced. The invention further applies to the field of carrying optical data, called “plasmonique”.

The invention particularly relates to the detection of pollutants in aqueous media, contaminants or biomarkers in the medical field, biological systems in the food or agricultural field; and many other applications particularly consisting of detecting traces of a type of molecules in a given medium quickly, simply and reliably.

### STATE OF THE RELATED ART

The document WO 2008/117087 discloses biosensors for detecting molecules sensitive to plasmon resonance and polarisation, the biosensors comprising a transparent substrate having a surface bearing a set of nano or micro-structured metal-coated “zones”, for plasmon resonance detection. Each “zone” in fact consists of a plurality of metallic nanoparticles wherein the shapes and sizes are suitable for functional molecules i.e. corresponding to biological, chemical or biochemical targets. The metallic nanoparticles may be in the form of elliptical nanoantennas such as nanorods or nanowires wherein one of the dimensions is between some tens of nanometres and some tens of micrometres. This type of nanoparticle has a high sensitivity to incident beam polarisation, which poses a problem. However, it is possible to adapt the geometry and dimensions of this type of nanoparticle to a desired resonance wavelength.

Moreover, it is known that cylindrical nanoparticle have a linear optical response which is not dependent on incident field polarisation; however, the resonance wavelength thereof is not readily tuned. It is not possible to obtain effective resonance with cylinders having a diameter greater than approximately 200 nanometres. For these nanoparticle sizes, the local electromagnetic field loses effectiveness.

It is known that Surface Enhanced Raman Spectroscopy (SERS) enables significant enhancement of the Raman signal of molecules deposited on nanostructured metallic structures. This property thus makes it possible to detect the presence and identify very small amounts of molecules, or even a single molecule. The enhancement effect is associated with the optical properties of metallic nanostructures and more specifically with surface plasmons. The document WO2005/043109 describes a functional assembly particularly comprising a substrate for samples, and a method based on the SERS effect. This system makes it possible to identify such molecules which are part of said sample, simply and inexpensively.

As stated above, enhancements enabling such observations require elongated particles such as cylinders, wires, ellipses, etc. or coupled structures (dimers or others). The main drawback of these nanostructure geometries is in that the intensity and position of the surface plasmon resonance are closely dependent on incident light polarisation. In this way, it is known that SERS enhancement is closely dependent on polarisation.

For SERS effect applications as sensors, this incident light polarisation involves positioning the substrate in the direction of polarisation of the excitation beam, with high precision, hence the dual constraint of suitable substrates and an experienced operator. Moreover, the system per se needs to maintain the polarisation. It is known that optical fibres do not maintain polarisation over the length thereof; in this way, it would appear to be difficult to use the SERS effect for detecting molecules, using optical fibres, the stability of the signal being practically impossible to obtain.

For some applications such as measurements in deep-sea environments, it is very difficult or even impossible to control the polarisation; in this way, the use of samples having a behaviour closely dependent on polarisation distorts the measurements significantly in these cases of application.

It should be noted that the problem of material polarisation dependence for optics has been known for many years, and only studies and developments relating to the non-linear optical polarisation properties, for solid materials, have been successfully completed to date.

Moreover, SERS type spectroscopy in a sensor requires a high plasmon resonance tunability and thus flexibility in the geometry and size of the nanostructures used.

In this way, it appeared to be advantageous and innovative to define SERS substrates producing strong enhancements while remaining non-polar, i.e. wherein the linear optical response is not dependent on incident field polarisation.

### DESCRIPTION OF THE INVENTION

The aim of the invention is that of remedying the drawbacks of the prior art and particularly that of providing nanoparticle forms wherein the linear optical response is not dependent on incident field polarisation.

For this purpose, a first aspect of the invention relates to a substrate having a surface comprising nanoparticles or groups of nanoparticles wherein the linear optical response is not dependent on the polarisation of the incident field of a Gaussian beam having an axis of propagation that is directed perpendicularly to said surface of the substrate.

The term Gaussian beam refers to all types of beams having a Gaussian shape, such as cylindrical, conical or other; the term perpendicular means strictly perpendicular but also substantially perpendicular i.e. deviating by few degrees about the perpendicular to the surface in question.

Characteristically, said groups of nanoparticles have a shape or an arrangement having a Cn-type axis of symmetry perpendicular to said [Cn-type] surface where n is a number equal to three or greater than four, in that said nanoparticles have a shape having a [Cn-type] axis of symmetry perpendicular to said [Cn-type] surface where n is a number greater than or equal to three, so as to enable strong enhancement of said beam in the vicinity of said surface.

If the particle (or nanoparticle in view of the dimensions thereof) is invariant by rotating about an axis perpendicular to the surface of the substrate (thus collinear with the incident beam axis) by an angle 2Pi/n, where n is greater than or equal to three, then the linear optical response is not dependent on beam polarisation. This n-order symmetry in relation to the axis of rotation is referred to as Cn.

According to one embodiment of the invention, said nanoparticles mainly have a star shape having at least three branches.

Furthermore, according to the invention, the nanoparticles may be metallic and/or semi-conducting. They preferentially have a size between a nanometre and some tens of micrometres.

Furthermore, according to the lattice wherein said nanoparticles are included, a minimum distance in the region of 200 nm is provided between each of said nanoparticles. This specific feature is explained hereinafter.

Moreover, the substrate preferentially consists of a transparent material with respect to ultraviolet, visible and/or infra-red wavelengths.

Interestingly, the size of said nanoparticles or groups of nanoparticles is chosen such that they are tuned over an incident beam wavelength Lo.

According to one specific embodiment of the invention, said nanoparticles are arranged on at least a part of said substrate, according to a regular, quasi-crystalline or random pattern. In this context, various alternative embodiments are possible without leaving the scope of the invention.

According to one embodiment of the invention, said substrate is arranged at one end of an optical fibre so as to enable the response of the system over the entire length of the optical fibre.

If the substrate is arranged in a microscope, it is sought to obtain polarisation on the whole microscope lens, regardless of the lighting.

The invention further relates to the use of such substrates for detecting and/or measuring molecules and/or chemical, biochemical or biological targets.

Advantageously, the invention relates to the use of such substrates for detecting and/or measuring molecules and/or supermolecules and/or particles in an aqueous and/or biological medium and/or in bodily fluids such as blood. According to this type of application, viruses or bacteria may be identified individually and/or measured. In this way, according to the invention, it would be possible to measure concentrations of molecules, particles or other substances in a given medium.

### BRIEF DESCRIPTION OF THE FIGURES

Further features, details and advantages of the invention will emerge on reading the description hereinafter, with reference to the appended figures, illustrating:

FIG. 1, a curve giving the position of the plasmon resonance (LSPR) according to the polarisation angle for a cylindrical nanoparticle;

FIG. 2, a curve giving the position of the plasmon resonance (LSPR) according to the polarisation angle for nanoparticle according to one embodiment of the invention;

FIG. 3, a curve giving the intensity of the plasmon resonance according to the polarisation angle for an elliptical nanoparticle;

FIG. 4, a curve giving the intensity of the plasmon resonance according to the polarisation angle for a nanoparticle according to one embodiment of the invention;

FIG. 5, an example of nanoparticles used according to the invention; and

FIG. 6, an example of an arrangement of nanoparticles according to the invention.

For more clarity, identical or similar elements are identified with identical reference signs throughout the figures.

### DETAILED DESCRIPTION

Interestingly, a nanoparticle fixed on a substrate described hereinafter is considered. In order to use the optical properties of said nanoparticle, a more or less convergent (Gaussian) beam is used, wherein the axis of propagation is normal to the surface of the substrate bearing said nanoparticle.

As a reminder, a Gaussian beam is a beam issued from a source having a profile governed by Gauss's law.

In a specifically innovative fashion, it has been demonstrated that if the particle (or nanoparticle in view of the dimensions thereof) is invariant by rotating about an axis perpendicular to the surface of the substrate (thus collinear with the incident beam axis) by an angle 2Pi/n, where n is greater than or equal to three, then the linear optical response is not dependent on beam polarisation. This n-order symmetry in relation to the axis of rotation is referred to as Cn, a term commonly used in group theory.

Moreover, if the particles or groups of particles are too close to one another, they tend to be “electromagnetically coupled”; this phenomenon occurs as soon as a so-called coupling distance between the particles is not observed; this distance is generally in the order of 200 nm. If the particles are mutually arranged at a distance less than the coupling distance, they are no longer non-polar and lose the order of symmetry thereof of 3 or more. However, if, as illustrated in FIG. 6, the nanoparticles are part of a hexagonal lattice (having an order equal to three), then the response remains independent of polarisation.

This involves particles of invariant polarisability by rotating the polarisation, for an incident beam directed perpendicular to the surface of the substrate at the incident point. The mathematical demonstration for a cylindrical (and thus Gaussian) beam is as follows:

The demonstration is based on the possibility of expressing a tensor in a spherical base. This is essentially based on the article by Jerphagnon, Chemia and Bonneville (Advances in Physics, 1978).

Within the scope of the hypotheses given above, the relationship between the polarisation of the nanoparticle and the incident electric field can be given by:

$${P}_{i} = {\sum }_{j} {α}_{i , j} {E}_{j}$$

or with a more general notation not requiring a Cartesian base: \vec{P}= α̅·\vec{E}

α is a tensor expressing the polarisability of the nanoparticle. The polarisability bears all the optical properties concerned by the scope of the invention.

The term α is usually expressed in Cartesian coordinates. For this demonstration, we have chosen a spherical base with Z as the reference axis of the spherical coordinates.

In Cartesian coordinates, the base consists of the 9 elements \vec{e}ᵢ\textcircled{×}\vec{e}ⱼ. In spherical coordinates, the breakdown is performed on the elements eⱼ^{m}, complying with the same algebra and having the same properties as spherical harmonics.

This gives

α̅=α₀⁰e₀⁰+α₁⁻¹e₁⁻¹+α₁⁰e₁⁰+α₁¹e₁¹+α₂⁻²e₂⁻²+α₂⁻¹e₂⁻¹+α₂⁰e₂⁰+α₂¹e₂¹+α₂²e₂²

In the case of metallic nanoparticles, there is no need to consider α₁^{m} or αⱼ^{±1} which are not physical (in this case, a phase change in the Pi field would give a different polarisability, which does not make sense). This leaves the terms α₀⁰ (isotropic polarisability) and α₂^{m} (elements indicating anisotropy).

If the system is invariant by rotating by an angle 2Pi/n, this invariance should be detected in the polarisability. For a rotation by an angle θ about the vertical axis, a coefficient αⱼ^{m} is multiplied by e^{-imθ} (Wigner matrix element for rotation which is simplified when rotation takes place about the z axis, which applies here). Therefore, if the system is designed to be invariant by rotating by an angle 2Pi/n, this should give

$${α}_{j}^{m} {e}^{- i 2 π \frac{m}{n}} = {α}_{j}^{m} .$$

It is clear that, under these conditions, αⱼ^{m} may be different to zero only if

$${e}^{- i 2 π \frac{m}{n}} = 1.$$

For n≧3, only the cases whereby m=n or m=0 allow

$${e}^{- i 2 π \frac{m}{n}} = 1.$$

This tensor has no elements where m>=3, therefore αⱼ^{m}≠0 only if m=0. The polarisability tensor is thus simplified to

α̅=α₀⁰e₀⁰+α₂⁰e₂⁰

Each of these elements is invariant by rotating about the Z axis, since for m=0, any rotation of the particle (or incident beam polarisation) results in a multiplication of these elements by

$${e}^{i 2 π \frac{0}{n}} = 1.$$

In this way, a particle of invariant polarisability by rotating the incident beam polarisation (for an incident beam directed along z) is obtained. Therefore, it has the same polarisability properties as a particle with cylindrical symmetry (with an axis Oz).

Finally, it should be noted that in the case of a non-zero numerical aperture beam, but wherein the optical axis merges with the axis of symmetry of the particle (Oz), the cylindrical symmetry is sufficient to ensure independence of the polarisability with respect to polarisation.

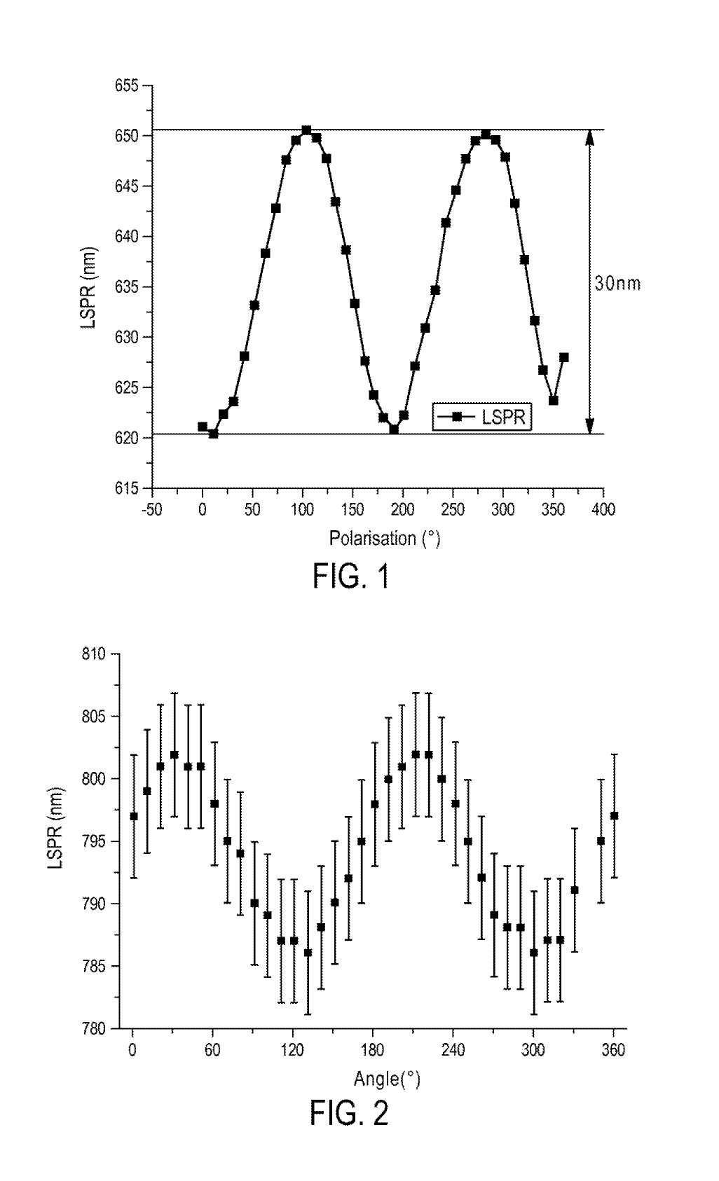

FIG. 1 illustrates the position of the plasmon resonance according to the polarisation angle for a cylindrical nanoparticle. This type of structure is known to be non-polar since the symmetry thereof is cylindrical with respect to the measurement axis perpendicular to the substrate and thus merged with the axis of symmetry of said nanoparticle. Theoretically, in this scenario, no polarisation effect should be observed, and the position of the plasmon resonance (LSPR) should be constant if a perfect cylindrical structure is involved. The only possible modifications of this position may be due to imperfections in the shape of the cylinders, induced by technological manufacturing problems. Unfortunately, it is observed in FIG. 1 that the position of the plasmon resonance (LSPR) is not constant but varies from 620 to 650 nm for a polarisation between 0° and 360°. This variation range in the region of 30 nm, about a mean position of 635 nm, is thus equivalent to an error of + or −2.4%, which is not at all satisfactory.

Interestingly, FIG. 2, showing the LSPR relating to a particle according to the invention, in this case in the form of a three-branched star, shows a very slight variation of this resonance. More specifically, the resonance is, in this case, situated at 794 nm+ or −10 nm, or an error of + or −1.5%. This imprecision observed is less than the uncertainty on the manufacturing tolerance, which is both novel and inventive per se.

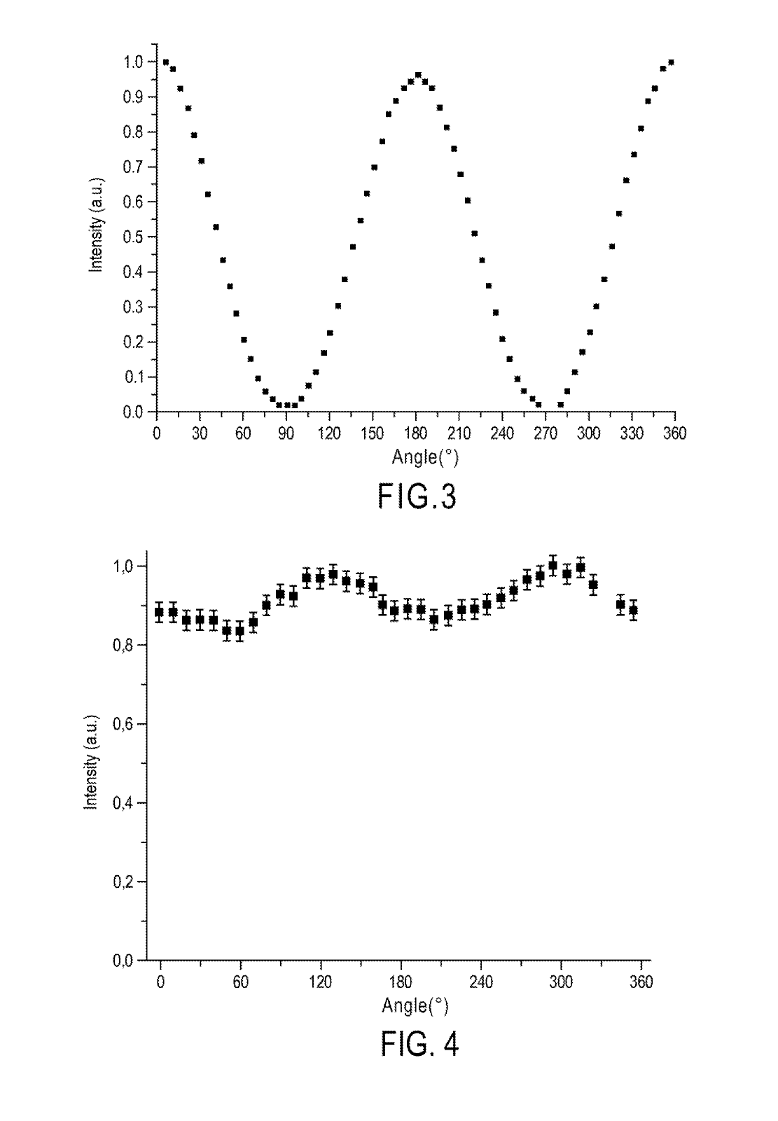

In respect of the intensity of plasmon resonance, FIGS. 3 and 4 show the inherent effects of the invention. Indeed, according to the curve in FIG. 3, relating an elliptical nanoparticle, i.e. having a geometry with an order of symmetry of 2, the intensity varies between 0 and 1. The intensity particularly becomes zero for some polarisation values (90° and) 270°, which corresponds to a polarisation perpendicular to the major axis of the ellipse. In these cases, the useable optical properties of the particles disappear and thus variability of these. It would thus appear to be clear that this type of nanoparticle shape is significantly polar and induces a significant decrease in the SERS signal.

In a different and advantageous manner, according to the invention and as shown in FIG. 4, the intensity of the plasmon resonance for a particle having a three-branched star shape, varies very slightly regardless of the polarisation angle.

Furthermore, this slight variation is essentially due to manufacturing imperfections. The length of each of the branches of the particle tested is in the order of 100 nm. More specifically, a mean intensity of 0.96 (a.u.) was measured, with a variation of + or −0.092 (a.u.), i.e. an error less than 10%.

This slight variation in intensity induces sufficient and advantageous independence of all the properties of the particle with respect to polarisation.

In this way, a number of well-known advantages associated with the use of particles having an order of symmetry greater than or equal to three are demonstrated: firstly, a wide variety of shapes fit this definition; hence, great flexibility both in the structure and in the geometry of the particles used. This makes it possible to obtain markedly superior field enhancement factors to those liable to be obtained with cylindrical or spherical particles. Moreover, the type of particles according to the invention enables a non-negligible reduction in the range of variation of the position and intensity of the plasmon resonance, as shown by the comparison of FIGS. 1 and 2 in respect of the position, and that of FIGS. 3 and 4 in respect of the intensity of the plasmon resonance.

Moreover, if particles having an axis of symmetry greater than or equal to three are too close to one another, they tend to be “electromagnetically coupled” below 200 nm of mutual spacing. In this case, three-branched stars in a square lattice, for example, are no longer non-polar. Therefore, the star can no longer be considered in isolation and loses the order of symmetry thereof greater than or equal to three. However, if such particles are arranged in a hexagonal lattice, they keep the same symmetry and the response thereof is thus independent of polarisation.

It is both innovative and inventive to propose surfaces (or substrates) having a surface comprising nanoparticles enhancing the optical response of an incident beam and simultaneously making it possible to do away with the incident light polarisation problem.

Furthermore, the use of nanoparticles according to the invention enables greater insensitivity to manufacturing imperfections. All industrialisation processes are thus optimised in that the manufacturing tolerances become less severe. For example, imperfections in the region of 10% do not give rise to any problems on the responses obtained.

As a general rule, the nanoparticles according to the invention may be metallic and/or semi-conducting, and have a maximum size between some tens of nanometres and some tens of micrometres. They are chosen so as to be tuned with the beam wavelength.

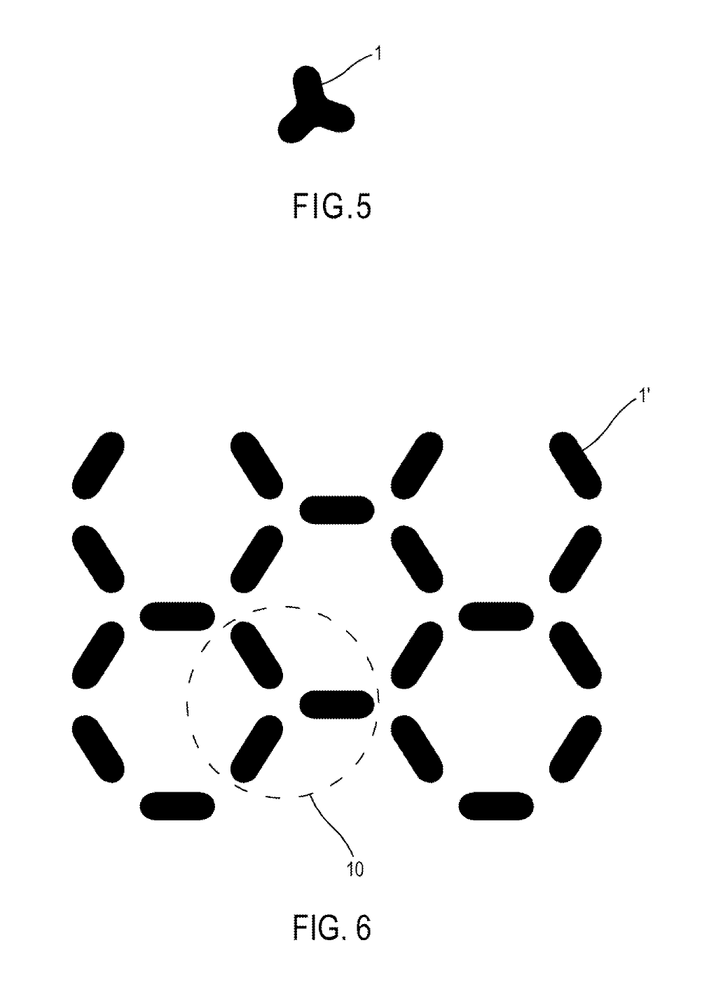

Moreover, it was observed that nanostar-shaped particles 1 enable ready tuning of the resonance wavelength. FIG. 5 shows an example of such particles wherein the nanostars have three branches.

FIG. 6 illustrates a set of nanoparticles organised according to a pattern having an order of symmetry of 3 or more, which is within the scope of the invention. Any regular, crystalline or random pattern organised in this way is covered by the invention. The pattern shown in FIG. 6 is a hexagonal lattice having an order of symmetry of three and formed for example from oblong nanoparticles 1′. The circled group 10 of nanoparticles has an order of symmetry of 3 and is thus within the scope of the invention.

The substrate is preferentially made of a transparent material with respect to the wavelengths in question; as an illustration, it may consist of glass in the visible range, calcium fluoride (CaF2) in the infrared range.

Electron beam lithography is a possible method for manufacturing nanoparticles on a substrate according to the invention. Indeed, the use of an electron beam for plotting patterns on a surface is known as electron beam lithography. The term electron lithography is also used. This technique is very suitable for manufacturing the nanoparticles according to the invention. Those skilled in the art will choose and determine a specific method, using commercially available equipment, according to their needs.

The uses of the invention are multiple and varied: detection, identification, measurement of molecules (in the broad sense), targets in aqueous, biological or bodily fluids. For example, identification and/or quantification of biomarkers, viruses and/or bacteria in blood; pollutants in an aqueous medium.

1. A substrate having a surface comprising:
nanoparticles or groups of nanoparticles wherein a linear optical response is not dependent on polarisation of incident field of a Gaussian beam having an axis of propagation that is directed perpendicularly to the surface of the substrate, wherein the groups of nanoparticles have a shape or an arrangement having an Cn-type axis of symmetry perpendicular to a Cn-type surface where n is a number equal to three or greater than four, in that the nanoparticles have a shape having an Cn-type axis of symmetry perpendicular to the Cn-type surface where n is a number greater than or equal to three, so as to enable strong enhancement of the beam in a vicinity of the surface.

2. The substrate according to claim 1, wherein the nanoparticles comprise a star shape having at least three branches.

3. The substrate according to claim 1, wherein the nanoparticles are metallic and/or semi-conducting.

4. The substrate according to claim 1, wherein the nanoparticles have a size between a nanometre and some tens of micrometres.

5. The substrate according to claim 1, wherein, according to a lattice wherein the nanoparticles are included, a minimum distance in a region of 200 nm is provided between each of the nanoparticles.

6. The substrate according to claim 1, wherein the substrate consists of a transparent material with respect to ultraviolet, visible and/or infra-red wavelengths.

7. The substrate according to claim 1, wherein a size of the nanoparticles or groups of nanoparticles is chosen such that they are tuned over an incident beam wavelength Lo.

8. The substrate according to claim 1, wherein the nanoparticles are arranged on at least a part of the substrate, according to a regular, quasi-crystalline or random pattern.

9. The substrate according to claim 1, wherein the substrate is arranged at one end of an optical fibre so as to enable a response of a system over an entire length of an optical fibre.

10. A method for detecting and/or measuring molecules and/or chemical, biochemical or biological targets utilizing the substrate according to claim 1.

11. The method according to claim 10, wherein the detecting and/or measuring step is conducted in an aqueous or biological medium or in bodily fluids.
